(19) United States
(12) Patent Application Publication
(10) Pub. No.: US 2016/0351058 A1
(43) Pub. Date: Dec. 1, 2016

(54) SYSTEMS AND METHODS FOR AIRCRAFT APPROACH SELECTION

(71) Applicant: Gulfstream Aerospace Corporation, Savannah, GA (US)

(72) Inventors: Carl Edward Wischmeyer, Savannah, GA (US); James T. Ward, Savannah, GA (US)

(21) Appl. No.: 14/724,951

(22) Filed: May 29, 2015

(51) Int. Cl. G08G 5/00

(52) U.S. Cl. CPC G08G 5/0039; G08G 5/0047

(57) ABSTRACT

Avionics systems, controllers, and methods are provided. An avionics system includes a display and a controller, and the controller performs a method. The controller is configured to generate an image with a runway characteristic criteria portion, an airport location criteria portion, an airport weather criteria portion, and an airport service criteria portion. The controller receives inputs corresponding to user selected criteria from the portions and filters a list of airports, approaches, runways, or combinations thereof based on comparisons between an approach information database and a user selected runway characteristic criterion and a user selected airport location criterion. The controller further filters the list based on a comparison between an airport services database and a user selected airport service criterion and based on a comparison between current or projected airport weather condition data and a user selected airport weather criterion. The display presents the list.

### TECHNICAL FIELD

The technical field relates generally to presentation and selection of approaches in aviation, and more particularly relates to avionics systems and methods of filtering airports, approaches, runways, or combinations thereof based on user selected criteria related to the airports, runways, and/or approaches.

### BACKGROUND

In aviation, different instrument approach procedures to different runways have different requirements. Some of these requirements are related to minimum heights or altitudes at which some action must be taken by the pilot of the approaching aircraft. For example, a decision height is a height at which a pilot of a descending aircraft must visually identify a runway. If the pilot does not visually identify the runway, the pilot must initiate a missed approach. A conventional method of making flight plan adjustments includes a pilot scanning publications that include such requirements. These publications do not typically include other relevant data to help a pilot determine whether to use a particular approach, such as current weather. Furthermore, a pilot typically manually enters any changes into conventional flight management systems based on the identified changed route.

As such, it is desirable to provide avionics systems, controllers, and methods that provide other relevant data to the pilot and provide for improved entry into a flight management system. In addition, other desirable features and characteristics will become apparent from the subsequent summary and detailed description, and the appended claims, taken in conjunction with the accompanying drawings and this background.

### SUMMARY OF EMBODIMENTS

Various non-limiting embodiments of aircraft, avionics systems, and media are disclosed herein.

In a first non-limiting embodiment, an avionics system includes, but is not limited to, at least one display and a controller. The controller is communicatively coupled with the display. The controller is configured to generate instructions for the display to present a runway characteristic criteria portion of an image, an airport location criteria portion of the image, an airport weather criteria portion of the image, and an airport service criteria portion of the image. The controller receives inputs corresponding to a user selected runway characteristic criterion, a user selected airport location criterion, a user selected airport weather criterion, and a user selected airport service criterion. The controller filters a list of airports, approaches, runways, or combinations thereof based on comparisons between an approach information database and at least one of the user selected runway characteristic criterion and the user selected airport location criterion. The controller further filters the list of airports, approaches, runways, or combinations thereof based on a comparison between an airport services database and the user selected airport service criterion and based on a comparison between current or projected airport weather condition data and the user selected airport weather criterion. The controller further generates a signal that causes the display to present the list of airports, approaches, runways, or combinations thereof.

In a second non-limiting embodiment, a controller includes, but is not limited to, a processor and a memory unit operatively coupled with the processor. The memory unit has instructions. The memory unit and the processor cooperate to cause the controller to generate instructions for the display to present a runway characteristic criteria portion of an image, an airport location criteria portion of the image, an airport weather criteria portion of the image, and an airport service criteria portion of the image. The memory unit and the processor further cooperate to cause the controller to receive inputs corresponding to a user selected runway characteristic criterion, a user selected airport location criterion, a user selected airport weather criterion, and a user selected airport service criterion. The memory unit and the processor further cooperate to cause the controller to filter a list of airports, approaches, runways, or combinations thereof based on comparisons between an approach information database and at least one of the user selected runway characteristic criterion and the user selected airport location criterion. The memory unit and the processor further cooperate to cause the controller to filter the list of airports, approaches, runways, or combinations thereof based on a comparison between an airport services database and the user selected airport service criterion and based on a comparison between current or projected airport weather condition data and the user selected airport weather criterion. The memory unit and the processor further cooperate to cause the controller to generate a signal that causes the display to present the list of airports, approaches, runways, or combinations thereof.

In a third non-limiting embodiment, a method for selecting an instrument approach to a runway includes generating, with a processor, instructions for a display to present a runway characteristic criteria portion of an image, an airport location criteria portion of the image, an airport weather criteria portion of the image, and an airport service criteria portion of the image. The method further includes receiving inputs corresponding to a user selected runway characteristic criterion, a user selected airport location criterion, a user selected airport weather criterion, and a user selected airport service criterion. The method further includes filtering a list of airports, approaches, runways, or combinations thereof based on a comparison between an approach information database and at least one of the user selected runway characteristic criterion and the user selected airport location criterion. The method further includes filtering the list of airports, approaches, runways, or combinations thereof based on a comparison between an airport services database and the user selected airport service criterion. The method further includes filtering the list of airports, approaches, runways, or combinations thereof based on a comparison between current or projected airport weather condition data and the user selected airport weather criterion. The method further includes presenting the list of airports, approaches, runways, or combinations thereof.

### BRIEF DESCRIPTION OF THE DRAWINGS

Advantages of the present embodiments will be readily appreciated as the embodiments becomes better understood by reference to the following detailed description, when considered in connection with the accompanying drawings wherein:

FIGS. 1A and 1B are simplified block diagrams illustrating a non-limiting embodiment of an avionics system in accordance with the teachings of the present disclosure; and

FIG. 2 is a flow diagram illustrating a non-limiting embodiment of a method for selecting an instrument approach in accordance with the teachings of the present disclosure.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Various non-limiting embodiments of avionics systems, controllers for avionics systems, and methods for selecting an instrument approach are provided. In general, the disclosure herein describes generation of a displayed image that presents search criteria to a pilot of an aircraft. The disclosure further describes filtering a list of approaches based on user selection inputs corresponding to the search criteria. The image is a graphical user interface that allows the pilot to choose an instrument approach by type of approach, destination of that approach (individual runway or airport in general), and/or the actual landing runway (as in a sidestep or circling approach). The filtered list of approaches includes approaches that meet specified criteria, rather than making the pilot read multiple approach plates. Runway and approach selection may also be driven by actual navigation performance (compared to Required Navigation Performance), runway length, and other considerations (such as runway contamination, winds, density altitude, aircraft weight and performance, etc.), as will be appreciated by those with ordinary skill in the art. Selection of an approach from the filtered list may bring up data-driven and/or conventional charts, and may be configured to program the flight management system. The systems and methods may also be applied to Standard Terminal Arrival Routes and Departure Procedures. A greater understanding may be obtained from reference to the drawings.

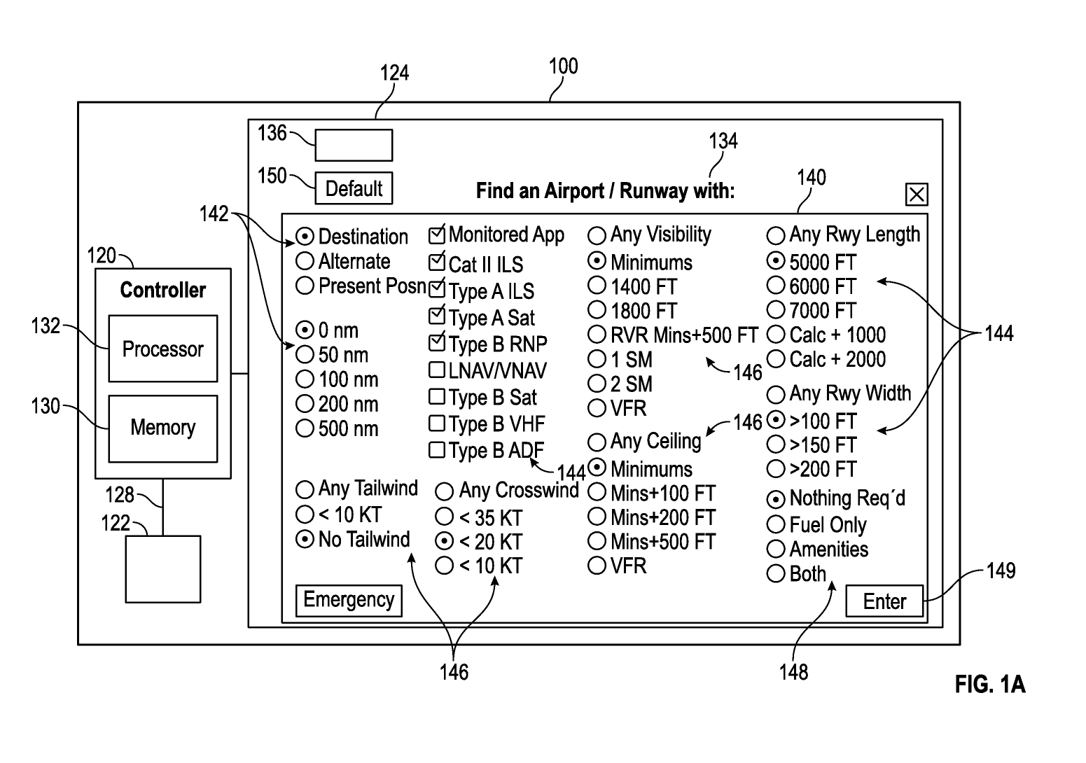

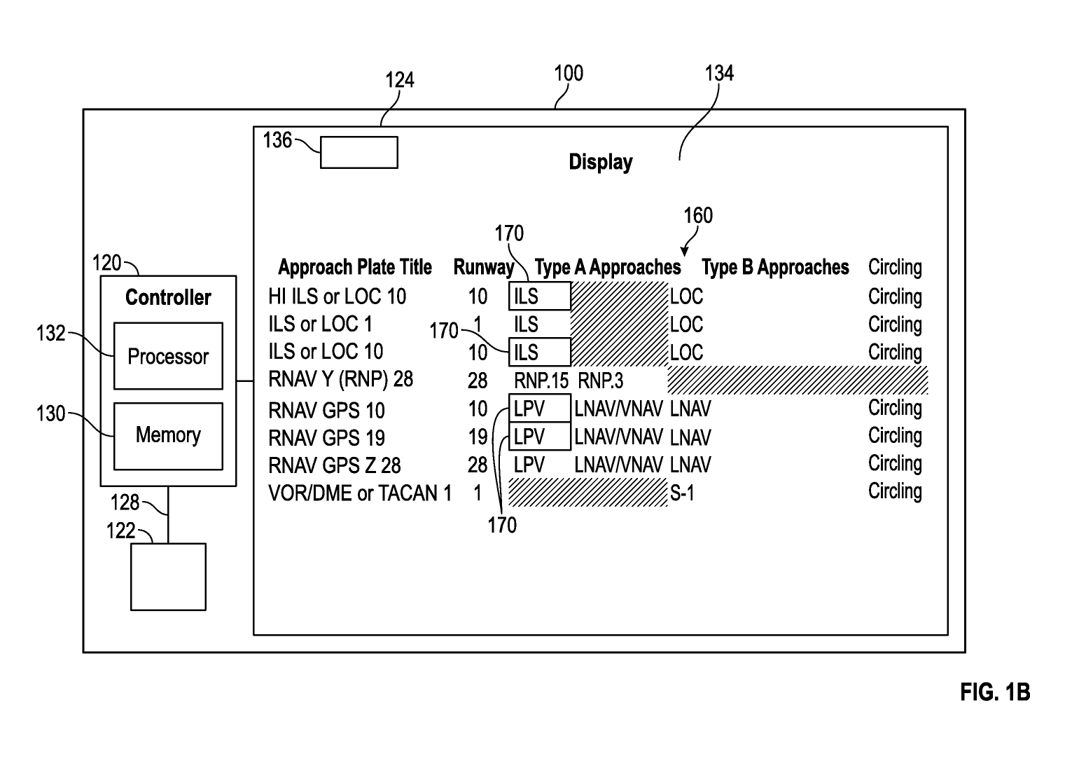

FIG. 1 is schematic view illustrating a non-limiting embodiment of an avionics system 100 for an aircraft in accordance with teachings of the present disclosure. In the embodiment provided, avionics system 100 is located in an airplane. In alternative embodiments, avionics system 100 may be located in other aircraft. For example, avionics system 100 may be located in a helicopter or airship.

Avionics system 100 includes a controller 120, a plurality of aircraft components 122, and a user interface 124. An interconnect 128 communicatively couples controller 120, aircraft components 122, and user interface 124 for electronic communication. In the example provided, interconnect 128 is a communication or network bus, as will be appreciated by those with skill in the art. It should be appreciated that any suitable network topology or physical medium may be utilized for electronic communication in avionics system 100.

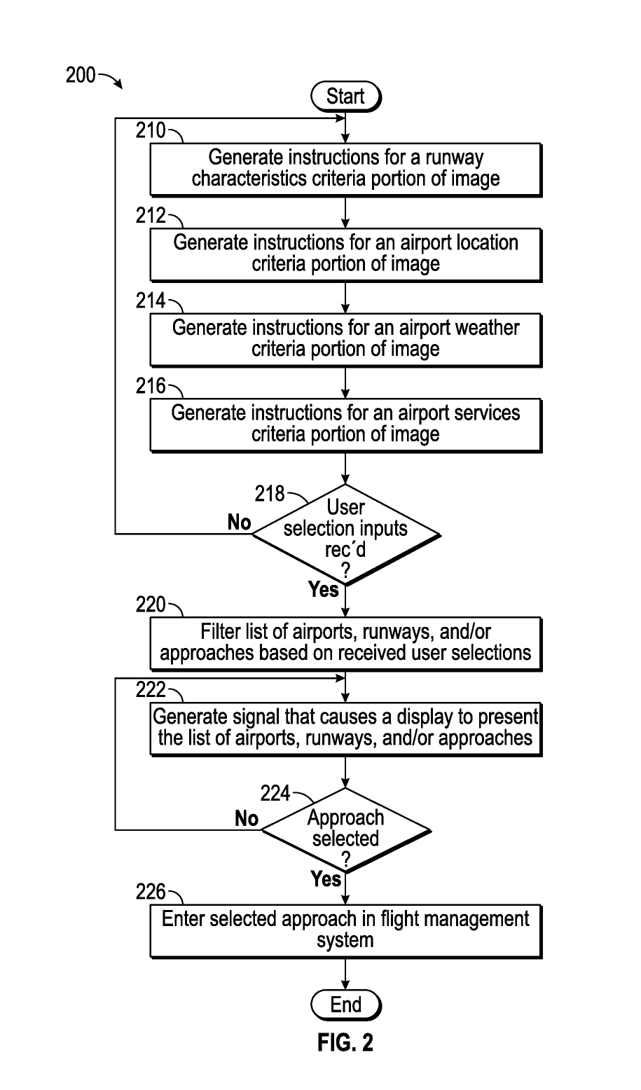

Controller 120 is a hardware device that carries out instructions of a computer program, as is well known to those skilled in the art. In the example provided, controller 120 is configured to execute the computer program to provide the functions of a conventional flight management system (FMS) in addition to performing the operations described in FIG. 2. For example, a flight management system program may include instructions of a computer program corresponding to operations of a conventional flight management system. Controller 120 may be implemented with one or more central processing units (“CPUs”), a microprocessor, an application specific integrated circuit (“ASIC”), a microcontroller, and/or other suitable device. Controller 120 includes one or more memory units 130 that store electronic data and computer programs. For example, memory units 130 may be flash memory, spin-transfer torque random access memory (STT-RAM), magnetic memory, phase-change memory (PCM), dynamic random access memory (DRAM), or other suitable electronic storage media. In the example provided, memory units 130 store control logic with instructions that cooperate with a processor 132 of controller 120 to perform operations of the method described below. Furthermore, controller 120 may utilize multiple hardware devices as is also appreciated by those skilled in the art.

Aircraft components 122 may be components that directly control flight of the airplane, components that monitor flight status of the airplane, components that communicate with ground or satellite based guidance systems, or other components related to operations of the airplane. For example, aircraft components 122 may include inertial reference units, GPS receivers, VOR and ILS receivers, air data computers, attitude/heading reference units (AHRS), magnetometers, their associated processors, MCDUs, other user interface devices, and other avionics components known to those with skill in the art. It should be appreciated that numerous other components 122 may be utilized in operation of the airplane. Components 122 may send information, data, and/or commands to controller 120, and vice-versa. For example, a component 122 may send position status or operational status to controller 120, as will be appreciated by those with ordinary skill in the art.

User interface 124 sends information to, and receives user inputs from, pilots and crew of the airplane. In the example provided, user interface 124 includes a display 134 and an input device 136. Display 134 is an electronic display that is electronically coupled with controller 120 to visually present information and data in an image 140 according to electronic signals generated by controller 120. For example, display 134 may include cathode ray tubes (“CRT”), light-emitting diodes (“LED”), plasma panels, liquid crystal displays (“LCD”), projected images from a Digital Light Processing (“DLP”) projector, and/or any other suitable electronic display technology.

Image 140 includes an airport location criteria portion 142, a runway characteristic criteria portion 144, an airport weather criteria portion 146, an airport service criteria portion 148, an enter button portion 149, and a default selections button 150. The portions 141, 142, 144, 146, and 148 will be described in detail below with reference to FIG. 2.

Although described with reference to a single display 134, it should be appreciated that user interface 124 may include multiple displays. For example, avionics system 100 may include one or more primary flight displays and one or more multi-function displays, as will be appreciated by those with ordinary skill in the art. Primary flight displays and multi-function displays may include multiple touchscreens that include sensors to detect contact by a user or other object with a screen of the touchscreen displays. The touchscreen displays further communicate the coordinates of the contact to controller 120, such as by an electronic signal over interconnect 128. Controller 120 associates the coordinates with a predefined user input and generates appropriate system commands based on the predefined user input. For example, the predefined user input may be associated with an input button or selectable list item displayed at the coordinates on the touchscreen.

Input device 136 may include trackballs, control sticks, or other suitable cursor control devices for the pilot or crew to communicate with controller 120. In some embodiments, input devices 136 are microphones for voice recognition, or may be integrated with the touch capabilities of a touch screen display, such as display 134. It should be appreciated that other input devices 136 may be utilized without departing from the scope of the present disclosure.

FIG. 2 is a flow diagram illustrating a non-limiting embodiment of a method 200 for selecting an approach to a runway. With continuing reference to FIG. 1, in the example provided, operations of method 200 are performed by controller 120. Controller 120 is communicatively coupled with display 134 and is configured to generate signals that cause display 134 to present image 140 for selection of approach criteria. Controller 120 includes control logic with instructions that cooperate with a processor to cause the controller to perform the operations of method 200. It should be appreciated that operations of method 200 may alternatively be performed by other controllers or devices.

Controller 120 generates instructions for display 134 to present a runway characteristics portion of an image in operation 210. For example, controller 120 may generate runway characteristic criteria portion 144 of image 140 by generating a selectable list of approach types, a selectable list of runway length criteria, and a selectable list of runway width criteria. The selectable lists include listed criteria that may be selected by a user as user selected criteria. For example, the user of system 100 may select a listed criterion by touching display 134 at the portion of image 140 that presents the criterion to select. Furthermore, the checkboxes of the selectable list of approach types or the radio buttons of the selectable lists of runway lengths and widths may be incorporated to visually indicate to the user which criterion is currently selected. Default selections button 150 may be selected to reset the selected criteria to a user defined default.

The selectable list of approach types includes a list of types of airports, approaches, runways, or combinations thereof available to the aircraft in which system 100 is installed. In the example provided, at least one Type A approach criterion, at least one Type B approach criterion, a Monitored Approach criterion, a Cat II ILS criterion, and an LNAV/VNAV criterion are provided in the selectable list of approach types. Type A approaches may also be known as precision approaches that use lateral guidance and vertical guidance. Type B approaches may also be known as non-precision approaches that use lateral guidance, but not vertical guidance. Monitored approaches use additional sources of information to monitor the primary guidance information. Cat III ILS approaches utilize ground based instruments and radio/visible light communication signals to guide the pilot during the approach. LNAV/VNAV approaches provide lateral and vertical navigation. It should be appreciated that other types of instrument or non-instrument approach types may be included in the selectable list of approach types without departing from the scope of the present disclosure.

Controller 120 generates instructions for display 134 to present an airport location criteria portion of the image in operation 212. For example, controller 120 may generate airport location criteria portion 142. In the example provided, controller 120 generates a selectable list of locations and at least one distance to generate the airport location criteria portion of the image. Accordingly, controller 120 may later filter a list of airports, approaches, runways, or combinations thereof to exclude runways that are farther than a user selected distance from a user selected waypoint or airport of the selectable list of locations and the at least one distance. The at least one distance may be selectable from a list, manually input, calculated by the FMS based on fuel, winds, and aircraft performance, or the like.

In the example provided, the selectable list of locations includes a current destination selection, an alternate destination selection, and a present position selection. The current destination selection selects the destination airport currently entered into the flight management system as the location criterion. The alternate destination selection selects the airport listed as the alternate destination in the flight management system as the location criterion. The present position selection selects the current position of the aircraft as the location criterion. For example, the aircraft components 122 may include a GPS receiver that provides the current position of the aircraft.

Controller 120 generates instructions for display 134 to present an airport weather criteria portion of the image in operation 214. For example, controller 120 may generate airport weather criteria portion 146. In the example provided, the airport weather criteria portion includes a selectable list of crosswind criteria, a selectable list of tailwind criteria, a selectable list of visibility criteria, and a selectable list of ceiling criteria. As will be appreciated by those with ordinary skill in the art, the ceiling refers to the lowest cloud height at the specified location that covers at least five eighths of the sky (in the US), and the tail/cross winds refer to wind speed and direction relative to the runway.

Controller 120 generates instructions for display 134 to present an airport service criteria portion of the image in operation 216. For example, controller 120 may generate airport service criteria portion 148. In the example provided, airport service criteria portion 148 includes a selectable airport services list that includes a fuel selection, an amenities selection, a “nothing required” selection, and a selection for both fuel and amenities. Accordingly, the pilot may search for an approach based on whether any required services are available at the airport which best satisfies the criteria. Additional and/or alternative criteria, such as runway contamination or slope, may be incorporated without departing from the scope of the present disclosure.

Controller 120 determines whether user selection inputs have been received corresponding to a user selected runway characteristic criterion, a user selected airport location criterion, a user selected airport weather criterion, and a user selected airport service criterion in operation 218. When no criteria have been received, method 200 returns to operation 210 to continue presenting the criteria portions of image 140.

When user selection inputs have been received, controller 120 filters a list of airports, approaches, runways, or combinations thereof based on the received user selection inputs in operation 220. For example, the user selection inputs may be received when a user selects an item of a selectable list and commands controller 120 to perform the filtering steps by pressing enter button 149, or the list or airports, approaches, runways, or combinations thereof may be generated dynamically as the criteria input by the user change, as the airplane position changes or as weather information is updated. The list of airports, approaches, runways, or combinations thereof is filtered based in part on a comparison between an approach information database and the user selected runway characteristic criterion and based on a comparison between the approach information database and the user selected airport location criterion. For example, the approach information database may include the information available from Terminal Procedure or approach plate publications.

The list of airports, approaches, runways, or combinations thereof is further filtered based in part on a comparison between an airport services database and the user selected airport service criterion. The information contained in the airport services database is typically not available on Standard Terminal Arrival Procedures or approach plate publications. Accordingly, filtering based on the separate databases reduces the burden placed on the pilot by conventional methods and systems to remember which airports have which services.

The list of airports, approaches, runways, or combinations thereof is further filtered based in part on a comparison between current or projected airport weather condition data and the user selected airport weather criterion. In the example provided, the airport weather condition data is transmitted to a wireless communication receiver, such as a satellite dish, in aircraft components 122. In some embodiments, airport weather condition data may be downloaded to controller 120 prior to takeoff

Controller 120 generates the list of airports, approaches, runways, or combinations thereof in the image in operation 222. For example, the filtered list 160 of airports, approaches, runways, or combinations thereof illustrated in FIG. 1B may be generated for presentation in a separate display or may be presented in display 134. The filtered list 160 presents the runway number and available approaches. FIG. 1B shows a non-limiting embodiment in which the approach plate title is included in the list of airports, approaches, runways or combinations thereof. It should be appreciated that electronic presentation of instrument approach procedures may omit the concept of named instrument approach plates, as is currently done for compatibility with paper instrument approach plates, In the example provided, the results of filtering based on no tailwind, Type A approach required, location KSAV, with winds 120 at 15 are presented. Boxes 170 indicate the approaches that match the criteria entered. It should be appreciated that other indicators may be incorporated without departing from the scope of the present disclosure.

Controller 120 determines whether an approach has been selected in operation 224. For example, the user may select the approach by touching the touchscreen of display 134 on the desired approach in the filtered list 160 of airports, approaches, runways, or combinations thereof. When no approach has been selected, method 200 returns to operation 222 to continue generating the filtered list of airports, approaches, runways, or combinations thereof.

When an approach selection input has been received, controller 120 proceeds to operation 226 to enter the selected approach in the flight management system program in response to an approach selection input corresponding to a selected approach from the list of airports, approaches, runways, or combinations thereof. In some embodiments, controller 120 also generates data-driven and/or conventional charts associated with the selected approach for presentation to the pilot.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An avionics system, comprising:
a display; and
a controller communicatively coupled with the display and configured to control the display to present an image, the controller further configured to:
generate instructions for the display to present a runway characteristic criteria portion of the image, an airport location criteria portion of the image, an airport weather criteria portion of the image, and an airport service criteria portion of the image;
receive inputs corresponding to a user selected runway characteristic criterion, a user selected airport location criterion, a user selected airport weather criterion, and a user selected airport service criterion;
filter a list of airports, approaches, runways, or combinations thereof based on a comparison between an approach information database and at least one of the user selected runway characteristic criterion and the user selected airport location criterion;
filter the list of airports, approaches, runways, or combinations thereof based on a comparison between an airport services database and the user selected airport service criterion;
filter the list of airports, approaches, runways, or combinations thereof based on a comparison between current or projected airport weather condition data and the user selected airport weather criterion; and
generate a signal that causes the display to present the list of airports, approaches, runways, or combinations thereof.

2. The avionics system of claim 1, wherein the controller is further configured to enter a selected approach in a flight management system program in response to receiving an approach selection input corresponding to the selected approach from the list of airports, approaches, runways, or combinations thereof.

3. The avionics system of claim 1, wherein the controller is further configured to generate a selectable list of approach types to at least partially generate the runway characteristic criteria portion of the image.

4. The avionics system of claim 3, wherein the controller is further configured to generate at least one Type A approach criterion, at least one Type B approach criterion, a Monitored Approach criterion, a Cat II ILS criterion, and an LNAV/VNAV criterion as at least part of the selectable list of approach types.

5. The avionics system of claim 1, wherein the controller is further configured to generate a selectable list of runway length criteria and a selectable list of runway width criteria to at least partially generate the runway characteristic criteria portion of the image.

6. The avionics system of claim 1, wherein the controller is further configured to generate a selectable list of locations and at least one distance to at least partially generate the airport location criteria portion of the image, and wherein the controller is further configured to filter the list of airports, approaches, runways, or combinations thereof to exclude runways that are farther than a user selected distance from a user selected waypoint or airport of the selectable list of locations and the at least one distance.

7. The avionics system of claim 6, wherein the controller is further configured to generate a current destination selection, an alternate destination selection, and a present position selection to at least partially generate the selectable list of locations.

8. The avionics system of claim 1, wherein the controller is further configured to generate a selectable list of crosswind criteria, a selectable list of tailwind criteria, a selectable list of visibility criteria, and a selectable list of ceiling criteria to at least partially generate the airport weather criteria portion of the image.

9. The avionics system of claim 1, wherein the controller is further configured to generate a selectable airport services list that includes at least a fuel selection and an amenities selection to at least partially generate the airport service criteria portion of the image.

10. A controller for an avionics system, the controller comprising:
a processor; and
a memory unit operatively coupled with the processor, the memory unit having instructions, the memory unit and the processor cooperating to cause the controller to:
generate instructions for the display to present a runway characteristic criteria portion of an image, an airport location criteria portion of the image, an airport weather criteria portion of the image, and an airport service criteria portion of the image;
receive inputs corresponding to a user selected runway characteristic criterion, a user selected airport location criterion, a user selected airport weather criterion, and a user selected airport service criterion;
filter a list of airports, approaches, runways, or combinations thereof based on a comparison between an approach information database and at least one of the user selected runway characteristic criterion and the user selected airport location criterion;
filter the list of airports, approaches, runways, or combinations thereof based on a comparison between an airport services database and the user selected airport service criterion;
filter the list of airports, approaches, runways, or combinations thereof based on a comparison between current or projected airport weather condition data and the user selected airport weather criterion; and
generate a signal that causes a display to present the list of airports, approaches, runways, or combinations thereof, and
wherein the memory unit and the processor further cooperating to generate a selectable list of crosswind criteria, a selectable list of tailwind criteria, a selectable list of visibility criteria, and a selectable list of ceiling criteria to at least partially generate the airport weather criteria portion of the image, and
wherein the memory unit and the processor further cooperate to generate a selectable list of approach types to at least partially generate the runway characteristic criteria portion of the image.

11. The controller of claim 10, wherein the memory unit and the processor further cooperate to cause the controller to enter a selected approach in a flight management system program in response to an approach selection input corresponding to the selected approach from the list of airports, approaches, runways, or combinations thereof.

12. A method for selecting an approach to a runway, the method comprising:
generating, with a processor, an instruction configured to control a display to present a runway characteristic criteria portion of an image, an airport location criteria portion of the image, an airport weather criteria portion of the image, and an airport service criteria portion of the image;
receiving inputs corresponding to a user selected runway characteristic criterion, a user selected airport location criterion, a user selected airport weather criterion, and a user selected airport service criterion;
filtering a list of airports, approaches, runways, or combinations thereof based on a comparison between an approach information database and at least one of the user selected runway characteristic criterion and the user selected airport location criterion;
filtering the list of airports, approaches, runways, or combinations thereof based on a comparison between an airport services database and the user selected airport service criterion;
filtering the list of airports, approaches, runways, or combinations thereof based on a comparison between current or projected airport weather condition data and the user selected airport weather criterion; and
presenting the list of airports, approaches, runways, or combinations thereof on the display.

13. The method of claim 12, further comprising entering a selected approach in a flight management system program in response to an approach selection input corresponding to the selected approach from the list of airports, approaches, runways, or combinations thereof.

14. The method of claim 12, wherein generating the runway characteristic criteria portion of the image further includes generating a selectable list of approach types.

15. The method of claim 14, wherein generating the selectable list of approach types includes generating at least one Type A approach criterion, at least one Type B approach criterion, a Monitored Approach criterion, a Cat II ILS criterion, and an LNAV/VNAV criterion.

16. The method of claim 14, wherein generating the runway characteristic criteria portion of the image further comprises generating a selectable list of runway length criteria and a selectable list of runway width criteria.

17. The method of claim 12, wherein generating the airport location criteria portion of the image further includes generating a selectable list of locations and at least one distance, and wherein the method further comprises filtering the list of airports, approaches, runways, or combinations thereof to exclude runways that are farther than a user selected distance from a user selected waypoint or airport of the selectable list of locations and the at least one distance.

18. The method of claim 17, wherein generating the selectable list of locations further includes generating a current destination selection, an alternate destination selection, and a present position selection.

19. The method of claim 12, wherein generating the airport weather criteria portion of the image further includes generating a selectable list of crosswind criteria, a selectable list of tailwind criteria, a selectable list of visibility criteria, and a selectable list of ceiling criteria.

20. The method of claim 12, wherein generating the airport service criteria portion of the image further includes generating a selectable airport services list that includes at least a fuel selection and an amenities selection.
